(19) United States
(12) Patent Application Publication
(10) Pub. No.: US 2025/0257572 A1
(43) Pub. Date: Aug. 14, 2025

(54) HIP AND RIDGE SHINGLES WITH IMPROVED PERFORMANCE

(71) Applicant: Owens Corning Intellectual Capital, LLC, Toledo, OH (US)

(72) Inventors: Haley Eileen Argersinger, Delaware, OH (US); Daniel James Buckwalter, Howard, OH (US); Benjamin R. Hoffman, Worthington, OH (US); David Vincent DeCarolis, Pataskala, OH (US)

(21) Appl. No.: 19/043,797

(22) Filed: Feb. 3, 2025

Related U.S. Application Data
(60) Provisional application No. 63/551,640, filed on Feb. 9, 2024.

(51) Int. Cl. E04D 1/30; B32B 5/02; B32B 7/06; B32B 7/12; E04D 1/28

(52) U.S. Cl. CPC E04D 1/30; B32B 5/024; B32B 7/06; B32B 7/12; E04D 1/28; B32B 2255/24; B32B 2419/06; E04D 2001/305

(57) ABSTRACT

An improved hip and ridge shingle is provided comprising a reinforced nail zone and a sealant applied to a bottom portion of the shingle and adapted to contact the reinforced nail zone of an adjacent shingle. Such a shingle structure surprisingly provides improved installation consistency and improved properties, such as reduced wind uplift and increased nail pull resistance.

### CROSS-REFERENCE TO RELATED APPLICATION

This application claims priority to and all benefit of U.S. Provisional Patent Application No. 63/551,640, filed on Feb. 9, 2024, the entire disclosure of which is fully incorporated herein by reference.

### TECHNICAL FIELD

The present invention relates generally to roof shingles for protecting a roof of a structure, and more particularly, to hip and ridge shingles with improved product consistency and performance.

### BACKGROUND

Roofing shingles (shingles) are used to protect a roof portion of a structure from damage caused by rain or snow exposure. Generally, shingles are nailed, stapled, glued, or otherwise attached to the roof portion of a structure to prevent water, snow, and other substances from damaging wood or other materials used to form the roof portion of a structure. Shingles are positioned on the roof in horizontal rows (known as courses) such that they overlap a previously applied row, causing water (rain, snow, etc.) to flow from an upper shingle to a lower shingle without contacting the structure underneath the shingles. Generally, a roof is formed from two sloped sections that meet along an upper edge. This upper edge is referred to as a ridge or hip depending upon where the upper edge is located on a roof Because shingles are applied to a roof with an overlap, as the shingles approach the ridge or hip portion of a roof, there comes a position on the roof that doesn't allow for shingles to be applied to overlap the previous course of shingles.

Hip and ridge shingles applied along a hip or ridge of a roof (i.e., transverse to the courses of shingles). These hip and ridge shingles span a gap or intersection between courses of shingles of roof planes that meet at a hip or ridge. These hip and ridge shingles are typically applied along the hip or ridge in a similar fashion, with the exposure portion of one hip and ridge shingle covering the headlap portion of an adjacent shingle on the hip or ridge. Thus, only the exposure portion of the shingles are exposed to the environment. This overlapping of the shingles causes water to pass from shingles on higher courses to shingles on the next lowest course of shingles without contacting the substrate. Accordingly, water passes from shingle to shingle and off the roof without contacting the substrate or entering the structure.

Attaching the shingles to the roof is typically achieved by the use of nails or other fastening devices that pass through the shingles and into or through the substrate. The fastening devices are typically placed through the headlap portion of the shingles so that they are overlapped by shingles in an adjacent higher course as described above. This placement of the fasteners prevents water from entering the structure through holes caused by the fasteners.

Accordingly, further improvements to installation and performance of hip and ridge shingles are desired to facilitate consistent installation, reduce wind uplift, and improve nail pull resistance.

### SUMMARY

The subject inventive concepts are directed to an improved hip and ridge shingle comprising a reinforced nail zone and a sealant applied to a bottom portion of the shingle and adapted to contact the reinforced nail zone of an adjacent shingle. Such a shingle structure surprisingly provides improved installation consistency and improved properties, such as reduced wind uplift and increased nail pull resistance.

In accordance with various aspects of the inventive concepts, the improved hip and ridge shingles comprise an overlay sheet comprising a first substrate coated with a first asphalt coating composition and an underlay sheet comprising a second substrate coated with a second asphalt coating composition. In any of the exemplary embodiments, the first and/or second asphalt coating composition may comprise polymer modified asphalt, oxidized asphalt, partially oxidized asphalt, or non-oxidized asphalt. The overlay sheet is attached to the underlay sheet such that a portion of the top surface of the underlay sheet extends beyond the back portion of the overlay sheet, forming an exposed or uncovered portion. The front portion of the overlay sheet is folded under the underlay sheet such that a front edge contacts the bottom surface of the underlay sheet, forming a folded portion. The shingle further includes a release material located on the underlay sheet in the uncovered portion, a reinforced nail zone located in the back portion of the top overlay sheet, proximate to the release material; and a sealant located on a portion of the bottom surface of the folded portion.

According to other aspects of the inventive concepts, a hip and ridge roofing material is provided that includes a laminated shingle having a foldable front portion, an opposing back portion, a top surface an opposing bottom surface, and a foldable centerline. The laminated shingle includes an overlay sheet comprising a first substrate coated with a polymer modified asphalt coating composition attached to an underlay sheet comprising a second substrate coated with an at least partially oxidized asphalt coating composition. The upper surface of the overlay sheet defines the top surface of the shingle and a lower surface of the underlay sheet defines the bottom surface of the shingle.

The foldable front portion of the laminated shingle is folded down below the underlay sheet such that a front edge of the foldable front portion contacts the bottom surface, forming a folded portion. In this manner, the folded portion of the shingle has an increased thickness compared to the non-folded portion of the shingle. In some exemplary embodiments, the folded portion is at least twice as thick as the non-folded portion of the shingle. In some exemplary embodiments, the folded portion comprises four layers, while the non-folded portion comprises two layers (i.e., the overlay and the underlay).

The laminated shingle further includes a reinforced nail zone located on the top surface in the back portion, proximate to a back edge and a sealant located on a bottom surface of the folded portion. The laminated shingle is foldable along the centerline for application to a roof.

Yet further aspects of the inventive concepts are directed to a method for producing a hip and ridge shingle. The method includes laminating an overlay sheet comprising a top overlay surface, a bottom overlay surface, a front portion, and a back portion to an underlay sheet comprising a top underlay surface and a bottom underlay surface. The method further includes forming a laminated shingle, wherein at least a portion of the overlay sheet is attached to the underlay sheet with an adhesive, such that a portion of a top surface of the underlay sheet extends beyond a back portion of the overlay sheet, forming an exposed or uncovered portion.

The front portion of the overlay sheet may be folded under the underlay sheet such that a front edge of the overlay sheet contacts a bottom surface of the underlay sheet, forming a folded portion.

The method further includes applying a release material to the underlay sheet in the uncovered portion, applying a nail reinforcement material to the back portion of the overlay sheet, proximate to the release material, and applying a sealant to a portion of the bottom surface of the folded portion.

In an alternative embodiment, the sealant is applied to a top surface of the shingle, proximate to a front edge and within the foldable portion of the shingle. In this manner, the sealant would also be located on the bottom surface of the folded portion.

The laminated shingle may be folded along a centerline for application to a hip or ridge of a roof.

In some exemplary embodiments, a hip and ridge shingle comprises: an overlay sheet comprising a top overlay surface, a bottom overlay surface, an overlay front edge, and an overlay back edge, with a height of the overlay sheet extending from the overlay front edge to the overlay back edge; an underlay sheet comprising a top underlay surface, a bottom underlay surface, an underlay front edge, and an underlay back edge, with a height of the underlay sheet extending from the underlay front edge to the underlay back edge; wherein the overlay sheet comprises a first substrate coated with a first asphalt coating composition; wherein the underlay sheet comprising a second substrate coated with a second asphalt coating composition; wherein the overlay sheet is attached to the underlay sheet such that the underlay back edge extends beyond the overlay back edge forming an exposed or uncovered portion; wherein the overlay front edge extends beyond the underlay front edge; wherein a release material is located on the top underlay surface in the uncovered portion; wherein a reinforced nail zone is located in the top overlay surface proximate to the release material; wherein a portion of the overlay sheet including the overlay front edge is folded under the underlay sheet such that the overlay front edge contacts the bottom underlay surface, forming a folded portion; wherein a sealant is located on a portion of a bottom surface of the folded portion; wherein the sealant is offset from a shingle front edge by a distance x; wherein the sealant has a height of y; wherein at least a portion of the release material is offset from a shingle rear edge by the distance x; and wherein the release material has a height of at least y.

In some exemplary embodiments, the reinforced nail zone and the release material are not immediately adjacent to one another.

In some exemplary embodiments, the inventive concepts encompass a package of hip and ridge shingles, the package comprising a first hip and ridge shingle as disclosed herein and a second hip and ridge shingle as disclosed herein, wherein the first hip and ridge shingle is rotated 180 degrees and stacked on top of the second hip and ridge shingle.

### BRIEF DESCRIPTION OF THE DRAWINGS

These and other features and advantages of the present invention will become better understood with regard to the following description and accompanying drawings in which:

FIG. 1 is a perspective diagram of a roof of a residential home;

FIGS. 2(a) and 2(b) illustrate an exemplary conventional hip and ridge shingle in an unfolded condition;

FIG. 3 illustrates an exemplary conventional hip and ridge shingle in an unfolded condition;

FIG. 4 illustrates a perspective view of an exemplary conventional hip and ridge shingle in a folded condition;

FIGS. 5(a)-5(c) illustrate a hip and ridge shingle in accordance with the present inventive concepts;

FIGS. 6(a) and 6(b) illustrate side perspective views of a folded hip and ridge shingle in accordance with the present inventive concepts;

FIG. 7 illustrates a perspective view of three exemplary hip and ridge shingles in orientation suitable for installation on the hip or ridge of a roof,

FIG. 8(a) illustrates a top view of three nested hip and ridge shingles formed with a nail zone reinforcement material in accordance with the present inventive concepts; and

FIG. 8(b) illustrates a top perspective view of three nested hip and ridge shingles formed with a nail zone reinforcement material in accordance with the present inventive concepts.

### DETAILED DESCRIPTION

Disclosed herein are improved hip and ridge shingles having reinforced nail zone and improved sealant bonding.

The terminology as set forth herein is for description of the various aspects only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless specified otherwise, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

Unless otherwise expressly defined, all technical and scientific terms used herein have the same meaning as commonly understood by a person of ordinary skill in the art.

Unless otherwise expressly stated, it is not intended that any method set forth herein be construed as requiring that its steps be performed in a specific order, nor that any apparatus article set forth herein be construed as requiring specific orders or orientations to its individual components.

As used herein, any disclosed numerical value is intended to refer to both exactly the disclosed numerical value and “about” the disclosed numerical value, such that either possibility is contemplated as an embodiment of the disclosed invention, unless the context clearly indicates otherwise. As used herein, the terms “substantially” and “about” are defined as at least close to (and includes) a given value or state (preferably within 10% of, more preferably within 1% of, and most preferably within 0.1% of).

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

Any composition described in the present disclosure can comprise, consist of, or consist essentially of the essential elements of the disclosure as described herein, as well as any additional or optional element described herein, or which is otherwise useful in roofing applications.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements.

As used herein the term “asphalt” is meant to include asphalts produced from petroleum refining, including residua from atmospheric distillation, from vacuum distillation, and from solvent de-asphalting units (including petroleum deasphalted asphalt “PDA”), recycled asphalt streams, such as re-refined motor oil bottoms and recycled asphalt shingles. Mixtures of different asphalts can also be used. The exemplary embodiments disclosed herein can also be used with natural bitumen, such as the products extracted from the oil sands in Alberta or asphalts derived from oil sands by various refinery processes.

By “roofing shingle coating asphalt” or “coating asphalt,” as used herein, is meant an asphalt that is suitable for use as a coating asphalt to make asphalt roofing shingles as defined by ASTM D 3462-16: a softening point minimum of from 190° F. (88° C.) to 320° F. (160° C.) and a penetration at 77° F. (25° C.) minimum of 15 decimillitres (dmm). This softening point is referred to herein as the “target softening point”. Asphalts falling under the ASTM D 3462-16 definition of coating asphalt are unfilled asphalts, prior to any inclusion of filler materials.

In other exemplary embodiments, the term “coating asphalt” meets one or more of the tighter specifications that may be used by shingle manufacturers. Some examples of these specifications include a softening point of from 200° F. (93° C.) to 215° F. (102° C.), a penetration at 77° F. (25° C.) of from 16 dmm to 22 dmm, a melt viscosity at 400° F. (204° C.) of from 150 centipoise (cps) to 450 cps, a durability of greater than 60 cycles in the Weatherometer, and a flashpoint of greater than 550° F. (288° C.). Other examples of suitable coating asphalts include those with a softening point of from 212° F. (100° C.) to 220° F. (104° C.), a penetration at 77° F. (25° C.) of from 16 dmm to 20 dmm, a melt viscosity at 400° F. (204° C.) of from 275 cps to 375 cps, and a flashpoint of greater than 550° F. (288° C.). In some manufacturers' specifications, a minimum specific target penetration of 15 dmm or 17 dmm is used, although there are a range of different manufacturer specifications.

By “paving grade asphalt,” as used herein, is meant a performance grade asphalt according to AASH20 17320-17 that has a softening point within the range of about 60° F. to about 130° F. and a penetration value of at least about 25 dmm. Paving grade asphalts are not typically used in roofing applications because such asphalts are not able to achieve the properties required to be considered “coating grade” asphalt, as defined by ASTM D 3462-16: a softening point minimum of from 190° F. (88° C.) to 235° F. (113° C.) and a penetration at 77° F. (25° C.) minimum of 15 dmm.

As used herein, the terms “shingle blow off” or “blow off” are defined as the occurrence of installed shingles being forced off a roof deck when the installed shingles are subjected to high winds. Also, the term “shingle blow through” or “blow through” are defined as the situation that occurs when a nail has been driven too deeply into the shingle and the nail head penetrates through at least the shingle overlay.

In order to simplify the description hereinafter, the term “ridge” is intended to encompass both the ridge and hip portions of a roof, as the exemplary embodiments described herein are applicable to both.

Roofing materials are applied to structures to prevent damage caused by rain, snow, and other types of precipitation. While there are various types of roofing materials, the following disclosure will focus on asphalt shingles. One of ordinary skill in the art will recognize that the general inventive concepts may be equally applicable to other types of shingles. An asphalt shingle is commonly formed from a fibrous substrate to which an asphalt or similar material has been applied. Granules are applied to a side of the substrate that is intended to face outward from the roof (and thus be exposed to the elements). The granules function to protect the substrate from damage due to UV rays, heavy rain, hail, impacts, and other damaging circumstances. The granules can also enhance the fire resistance of the shingle. These granules can also form a decorative surface feature (e.g., pattern, color) on the shingle. The side of the shingle opposite the granules is often coated with a substance intended to prevent the shingle from adhering to other shingles during shipment and storage.

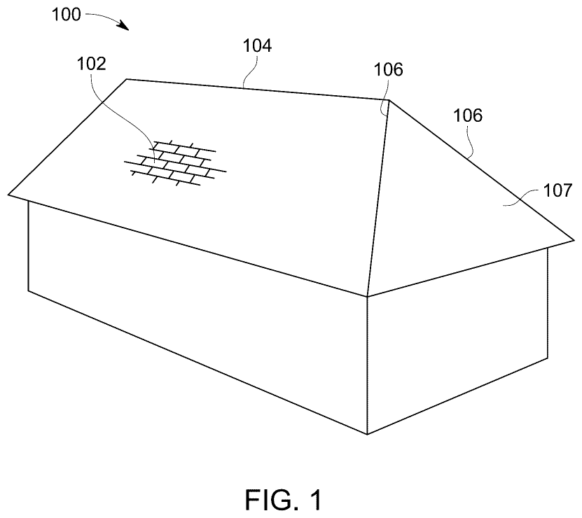

FIG. 1 provides a diagram of a roof structure 100. The roof 100 is a shingled roof, covered with individual shingles 102. The sides of the roof 100 come together to form a ridge 104 at the top of the roof 100. Hips 106 are formed when an inclined roof plane 107 meets the sides of the roof, instead of a gable end. The hips 106 extend from the eaves of the roof to the ridge 104. The roof 100 also has a leading edge at a lower edge of each side. The shingles 102 of the roof 100 are applied in courses on top of an optional underlayment (not shown) and sheeting and/or decking (not shown). The shingles 102 may be single-layer three-tab shingles, or may be laminate shingles, such as the shingles described in U.S. Pat. Nos. 8,430,983 and 9,121,178, which are incorporated herein by reference in their entirety. Shingles that are designed to cover hips, ridges, and other such plane intersections or edges are commonly referred to as “hip and ridge” shingles, ridge covers, and the like.

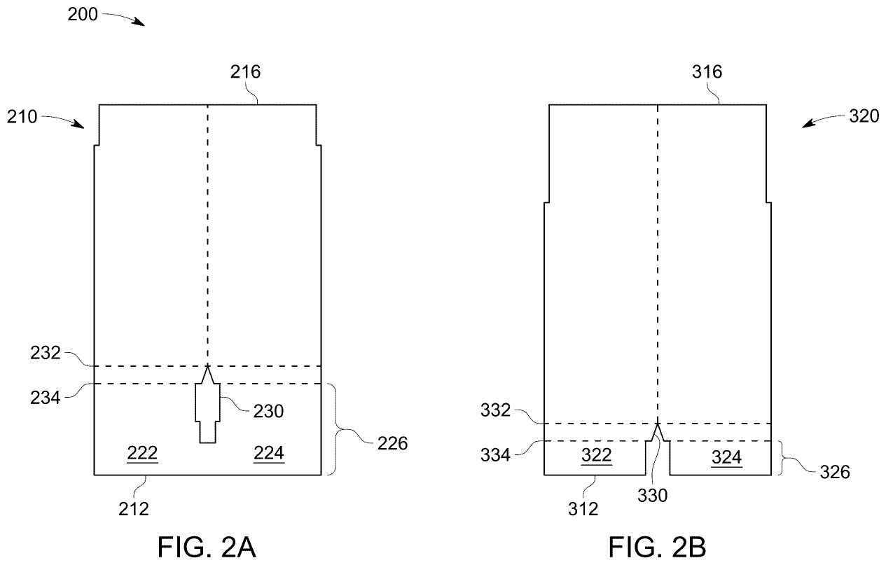

In any of the aspects disclosed herein, the hip and ridge shingle may comprise a laminated shingle 200 having an overlay sheet (FIG. 2(a)) and an underlay sheet (FIG. 2(b)). The overlay and underlay sheets each comprise an asphalt coated substrate, whereby the substrates are coated with the same or a different asphalt coating material. The asphalt coating material may include various types or grades of asphalt, including, for example, flux, paving grade asphalt blends, propane washed asphalt, recycled or reclaimed asphalt, and/or blends thereof. The asphalt coating material may be oxidized, non-oxidized, or partially oxidized. Effective blends of asphalt or bituminous materials are understood by those of ordinary skill in the art.

The asphalt coating may include one or more fillers, such as a filler of finely ground inorganic particulate matter, such as ground limestone, dolomite or silica, talc, sand, cellulosic materials, fiberglass, calcium carbonate, or combinations thereof. In some exemplary aspects, the one or more fillers is included in at least 10 wt. %, based on the total weight of the polymer-modified asphalt composition. In some exemplary embodiments, the one or more fillers are included in about 20 wt. % to about 90 wt. %, including, for example, about 25 wt. % to about 77 wt. %, about 30 wt. % to about 75 wt. % and about 40 to about 72 wt. %, based on the total weight of the polymer-modified asphalt composition. In some exemplary embodiments, the asphalt composition further comprises various oils, fire retardant materials, and other compounds conventionally added to asphalt compositions for roofing applications.

In any of the exemplary aspects, the overlay and/or underlay sheets may comprise a polymer modified asphalt coating, such as, for example, the polymer modified coating composition disclosed in U.S. Pat. No. 11,473,305, the contents of which are incorporated herein by reference in their entirety. The polymer modified coating comprises an asphalt material that is modified with one or more polymers. In some aspects, the coating composition further comprises a secondary additive that is a wax, fatty acid amide, or other viscosity reducing material.

According to various aspects, the asphalt material used in the asphalt composition of the overlay and/or underlay sheet includes at least a paving-grade asphalt. Any suitable paving-grade asphalt(s) can be used, for example paving asphalts which meet the PG 64-22 specifications (AASHTO M320). PG 64-22 is the most common paving specification in the United States. Paving asphalts were previously graded by viscosity and a common asphalt that is similar to the PG 64-22 grade asphalt and also usable in this method, is the old AC20 grade asphalt (ASTM D 3381). Other examples of suitable paving-grade asphalts include PG 67-22, PG 70-22, PG 58-22, PG 58-28, PG 58-22, PG 70-16, PG 70-10, PG 67-10, pen grade 40/50, pen grade 60/70, pen grade 85/100, pen grade 120/150, AR4000, AR8000, and AC/30 grade.

The paving grade asphalt may be included in the asphalt coating composition an amount from about 15 to about 80 wt. %, including about 17 wt. % to about 50 wt. %, including about 20 wt. % to about 45 wt. %, about 22 wt. % to about 40 wt. % and about 24 to about 35 wt. %, based on the total weight of the asphalt coating composition.

Optionally, as mentioned above, one or more additives may be added to the paving-grade asphalt, including one or more polymer additives and, optionally, a secondary additive. The polymer additive(s) may include any suitable polymer, or any suitable mixtures of different polymers. In some exemplary embodiments, the polymer additive comprises an elastomeric radial or linear polymer. In some exemplary embodiments, the polymer additive comprises a copolymer such as a linear or radial copolymer. In some embodiments the polymer additive comprises one or more of atactic polypropylene (APP), isotactic polypropylene (IPP), styrene-butadiene block copolymer (SBS), chloroprene rubber (CR), amorphous polyolefin, SBR latex, natural and reclaimed rubbers, butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated SBS, and vinyl acetate/polyethylene (EVA). According to other exemplary aspects, the polymer additive may comprise a radial polymer or a combination of linear and radial polymers. Examples of polymer modifiers are also disclosed in U.S. Pat. No. 4,738,884 to Algrim et al. and U.S. Pat. No. 3,770,559, to Jackson, the contents of which are incorporated herein by reference in their entirety. In some exemplary embodiments, the asphalt is modified with styrene-butadiene block copolymer (radial SBS).

When present, the polymer additive is included in the asphalt coating composition in an amount from about 0.5 wt. % to about 20.0 wt. %, based on the total weight of the asphalt coating composition. In some exemplary embodiments, the polymer additive is included in an amount from about 1.0 to about 15.0 wt. %, or from about 1.5 to about 10.0 wt. %, or from about 2.0 to about 7.0 wt. %, or from about 2.5 to about 6.8 wt. %, or from about or from about 3.0 to about 6.5 wt. %, or from about 3.5 to about 6.2 wt. %, or from about 5.5 to about 6.15 wt. %, based on the total weight of the asphalt coating composition. In some exemplary embodiments, the polymer additive is included in the asphalt coating composition in an amount of about 6.0 wt. % to about 6.5 wt. %, based on the total weight of the asphalt coating composition.

In any of the exemplary aspects, a secondary additive may be included in the asphalt coating composition. The secondary additive may comprise a viscosity reducing agent, such as one or more of a wax, a fatty acid ester, a fatty acid ester salt, and/or a fatty acid amide. Any type of wax, or a mixture of different waxes, capable of functioning as described herein can be used in the method. The wax may have a high congealing point or a high drop melt point of at least about 75° C., specifically at least about 90° C., and more specifically at least about 100° C. When referring to wax testing, the term “melt point” refers broadly to either congealing point or drop melt point, which are defined by ASTM D 938 in the case of congealing point and ASTM D 3954 in the case of drop melt point. Also, wax can be characterized by penetration or hardness (ASTM D5 or ASTM D 1321), density (ASTM D1505), viscosity (ASTM D 4402 or ASTM D88), or acid value (ASTM D 1386).

In any of the exemplary aspects, the wax may comprise one or more of a paraffin wax and a non-paraffin wax. Paraffin waxes typically have melting points below 70° C. and have less than 45 carbon atoms. Non-paraffin waxes typically have melting points above 70° C. and have more than 45 carbon atoms. The non-paraffin wax can be one or more of a natural wax, a modified natural wax, a partial synthetic wax, and a full synthetic wax. Non-limiting examples of suitable partial and fully synthetic waxes include ethylene bis-stearamide wax (EBS), Fischer-Tropsch wax (ET), oxidized Fischer-Tropsch wax (FTO), stearic acid pitch, polyolefin waxes such as polyethylene wax (PE), oxidized polyethylene wax (PEO), polypropylene wax, polypropylene/polyethylene wax, alcohol wax, silicone wax, petroleum waxes such as microcyrsatlline wax, and chlorinated wax. Any suitable mixtures of different waxes can also be used. For example, the wax can include a blend of a Fischer-Tropsch wax and a polyethylene wax. In some exemplary embodiments, the wax is a non-paraffinic wax with a high melting point (greater than 70° C.). In various exemplary embodiments, the wax has a melting point of at least 100° C., such as at least 120° C., or at least 130° C., or at least 140° C.

The wax may comprise a naturally occurring wax can be derived from a plant, animal or mineral. Some examples of natural waxes that may be suitable include plant waxes such as candelilla wax, carnauba wax, rice wax, Japan wax and jojoba oil; animal waxes such as beeswax, lanolin and whale wax; and mineral waxes such as montan wax, ozokerite and ceresin.

In some exemplary aspects, the secondary additive may comprise at ethylene bistearamide (EBS), which has a melt point of 140 to 146° C., a penetration hardness at 25° C. of about 1 dmm, a density of from about (8.49 lbs/gal), and an acid number of 4. EBS is a brittle wax-like solid formed from the reaction of an amine with hydroxystearic acid. The formed hydroxystearamide is a high melting point wax-like material that is extremely resistant to acids and alkalis in contrast to natural and synthetic ester waxes.

The secondary additive may alternatively comprise a salt of a fatty acid ester, such as a fatty acid ester derived from a plant or animal. Alternatively, or in addition, the secondary additive may comprise a Fischer-Tropsch wax with a melt point of greater than 100° C. and a hardness at 25° C. from 1 dmm to a value so soft that it could not be measured by the techniques in ASTM D5. In another exemplary embodiment, the secondary additive is a polyethylene wax with a melt point of from 100 to 125° C., a hardness at 250° C. of from 1 to 7 dmm, a density of from 0.91 to 0.95 gm/cc, a viscosity of from 20 to 450 cps at 140° C., and a nil acid number. In another exemplary embodiment, the wax is an oxidized polyethylene wax with melt point of from 135 to 140° C., a hardness at 25 C of <0.5 dmm, a viscosity of from 3600 to 4500 cps at 150° C., and acid number of 30. In some exemplary embodiments, the secondary additive is one or more fatty acid amides. Fatty acid amides are amides produced from the reaction of a fatty acid and an amine. The fatty acid amide can be a monoamide, a substituted amide, a bisamide, a methylol amide, an ester amide, an alkyl urea, and the like. Non-limiting examples of suitable fatty acid amides include oleamide, stearamide, erucamide, behenamide, N-oleylpalmitamide, N-stearylerucamide, ethylene bis-stearamide (EBS), and ethylene bis-oleamide.

In any of the exemplary aspects, the secondary additive may be included in the polymer modified coating asphalt composition in an amount from about 0.01 wt. % to about 20.0 wt. %, based on the total weight of the polymer modified coating asphalt composition. In some exemplary embodiments, the secondary additive is included in an amount from about 0.5 to about 15.0 wt. %, or from about 1.0 to about 10.0 wt. %, or from about 1.2 to about 7.0 wt. %, or from about 1.5 to about 5.0 wt. %, or from about 1.6 to about 3.0 wt. %, or from about 1.7 to about 2.5 wt. %, or from about 1.75 to about 2.4 wt. %, or from about 1.8 to about 2.3 wt. %, or from about 1.85 to about 2.2 wt. %, or from about 1.90 to about 2.15 wt. %, or from about 1.95 to about 2.10 wt. %, or from about 1.98 to about 2.05 wt. %, based on the total weight of the polymer modified coating asphalt composition. The secondary additive may be included in the polymer modified coating asphalt composition in an amount of about 2.0, based on the total weight of the polymer modified coating asphalt composition.

According to any of the exemplary aspects, the asphalt coating composition may comprise about 60 to about 99 wt. % of a paving grade asphalt, about 1 to about 10 weight percent of a polymer additive, and 0.5 to about 8.0 weight percent of the secondary additive, based on the total weight of the polymer modified coating asphalt. In some exemplary embodiments, the polymer modified coating asphalt comprises about 80 to about 95 wt. % of a paving grade asphalt, about 2 to about 7 weight percent polymer additive, and about 2.0 to about 5.0 weight percent secondary additive, based on the total weight of the polymer modified coating asphalt. In some exemplary embodiments, the polymer modified coating asphalt comprises about 80 to about 95 wt. % of a paving grade asphalt, about 1 to about 8 weight percent polymer additive, and about 1.85 to about 2.4 weight percent secondary additive, based on the total weight of the polymer modified coating asphalt. In some exemplary embodiments, the polymer modified coating asphalt comprises about 80 to about 95 wt. % of a paving grade asphalt, about 1 to about 8 weight percent polymer additive, and about 1.9 to about 2.4 weight percent secondary additive, based on the total weight of the polymer modified coating asphalt. A filler may then be added to the polymer modified asphalt composition, such that the filled asphalt composition comprises about 30 to 80 wt. % of filler material and about 20 to 70 wt. % of the polymer modified asphalt composition. In some exemplary embodiments, the filled asphalt composition comprises about 45 to 70 wt. % of filler material and about 30 to 55 wt. % of the polymer modified asphalt composition.

In any of the aspects disclosed herein, the hip and ridge shingle includes an overlay sheet comprising a polymer-modified asphalt coating composition and an underlay sheet comprising oxidized or partially oxidized asphalt. According to other aspects, the hip and ridge shingle includes both an overlay sheet and underlay sheet comprising a polymer-modified asphalt composition. In accordance with yet further aspects, the hip and ridge shingle includes an overlay and underlay sheet comprising any variety of asphalt coating contemplated herein or otherwise known in the roofing industry.

Referring now to FIGS. 2(a) and 2(b), an exemplary hip and ridge shingle 200 is shown. The shingle 200 includes an overlay sheet 210 (FIG. 2(a)) attached to an underlay sheet 320 (FIG. 2(b)). The overlay sheet 210 has a top overlay surface and a bottom overlay surface and includes a front or “foldable” edge 212 and a back edge 216. The underlay sheet 320 includes a top underlay surface and a bottom underlay surface and similarly includes a front or “foldable” edge 312 and a back edge 316. The overlay 210 and underlay 320 sheets have foldable tabs 222, 224, 322, and 324, respectively, defining foldable regions 226 and 326. The overlay 210 and underlay 320 sheets each optionally include at least one folding perforation 232, 234, 332, 334 to facilitate folding foldable tabs 222, 224, 322, 324 into a folded region, described in more detail below. Such folding perforations are optional and the overlay and/or underlay regions may optionally be free of any perforations. Foldable regions 226 and 326 further include central notches 230 and 330 to further facilitate alignment and folding.

The overlay sheet 210 attaches or is “laminated” to the underlay sheet 220 by joining at least a portion of a contact area formed between the bottom overlay surface and the top underlay surface. The overlay sheet 210 may be attached to the underlay sheet 320 using an adhesive or any other suitable attachment means. In some embodiments, the entire contact area between the overlay and underlay sheets 210, 320 is joined with an adhesive. In some embodiments, only portions of the contact area between the overlay and underlay sheets 210, 220 is joined with an adhesive. The adhesive may comprise a continuous application of adhesive over the entire contact area, or the adhesive may comprise one or more discrete dots, lines, or the like.

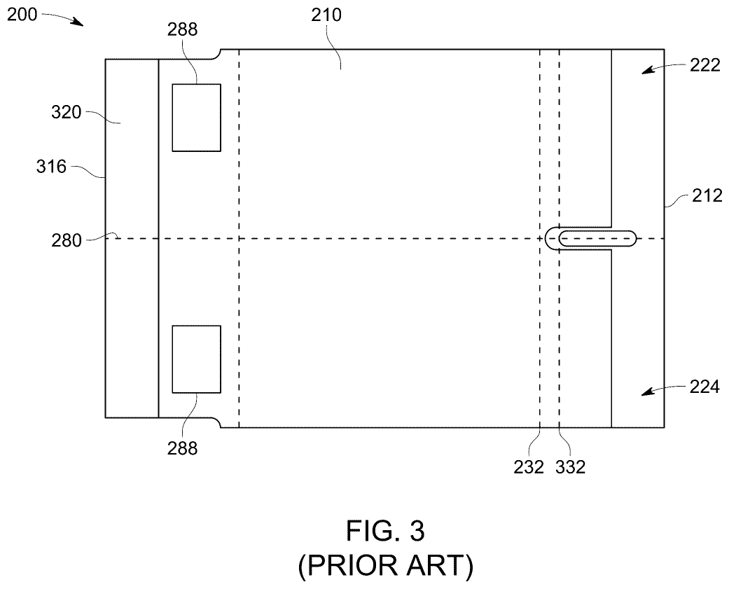

The overlay sheet 210 is applied to the underlay sheet 320, such that the sheets are substantially in alignment, although the front edges 212, 312 and back edges 216, 316 may or may not be aligned. In some exemplary aspects, as illustrated in FIG. 3, the overlay sheet 210 is attached to the underlay sheet 320 such that a portion of the top underlay surface extends beyond the back edge of the overlay sheet 216, forming an exposed or uncovered portion, and a portion of the overlay sheet extends past the underlay sheet at the front edge 212.

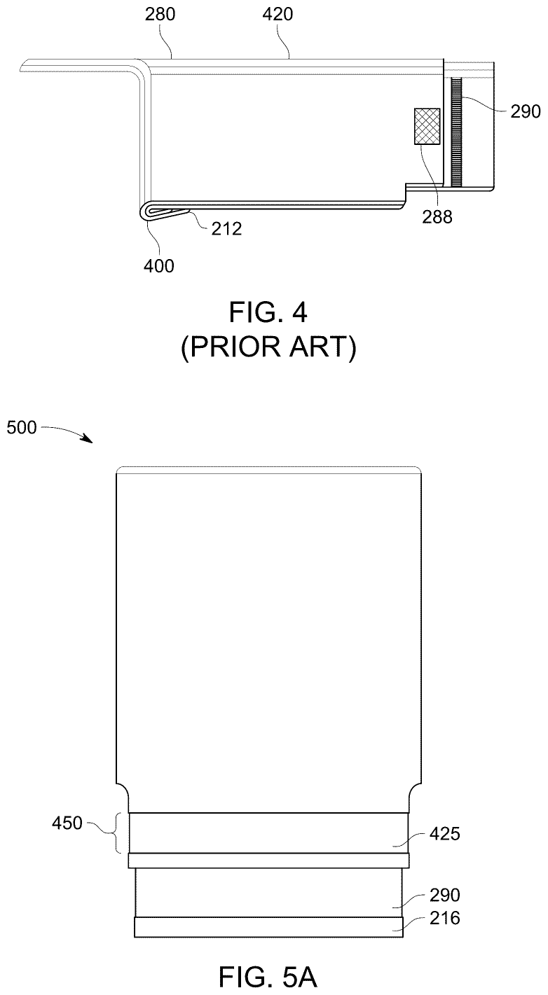

FIG. 4 illustrates a conventional folded hip and ridge shingle, whereby foldable tabs 222, 224, 322, and 324 are folded beneath the shingle such that front edge 212 contacts the bottom underlay surface and the folded portion forms a folded edge 400 (also known as a “bull nose”). The foldable tabs 222, 224, 322, 324 may be bent at any appropriate angle, such as approximately ninety degrees, along the one or more folding perforations 232, 234, 332, 334 that are spaced apart by some distance to form folded edge 400 of the shingle. The shingle may then be folded along centerline 280 to an appropriate degree for a particular hip or ridge roof application. In any of the various aspects, the shingle may be folded to an angle of about 10 degrees to about 120 degrees, including to an angle of about 45 to 90 degrees, or any angle therebetween. Folding the shingle along centerline 280 forms a ridge bend 420. Preferably the bending and folding are done at elevated shingle temperatures, preferably above 70° F. and more preferably between 80° F. and 120° F.

Once folded, the hip and ridge shingle may be installed on a roof 100, such that the ridge bend 420 extends over the ridge or other edge portion of a roof 100. The shingle may be attached to the roof 100 by any suitable means, such as, for example, adhesive, nails, screws, staples, sealant, or other fastening devices. Conventionally, hip and ridge shingles include a sealant 288 on at least a portion of the top surface of the overlay sheet 210. The sealant may be applied to a portion of the top surface of the overlay sheet 210 proximate to, but spaced from, the back edge 216. Such conventional shingles may further include a release section 290 applied between the back edge 216 and the sealant 288. In any of the exemplary aspects, the release section 290 may be spaced from, abut, or overlap the sealant 288. The release section may be in the form of a release tape, release coating, or other known release mechanism, and is used to prevent the sealant from adhering to adjacent shingle, when stacked or packed for shipping. The release section 290 is readily separated from the sealant 288 prior to installation.

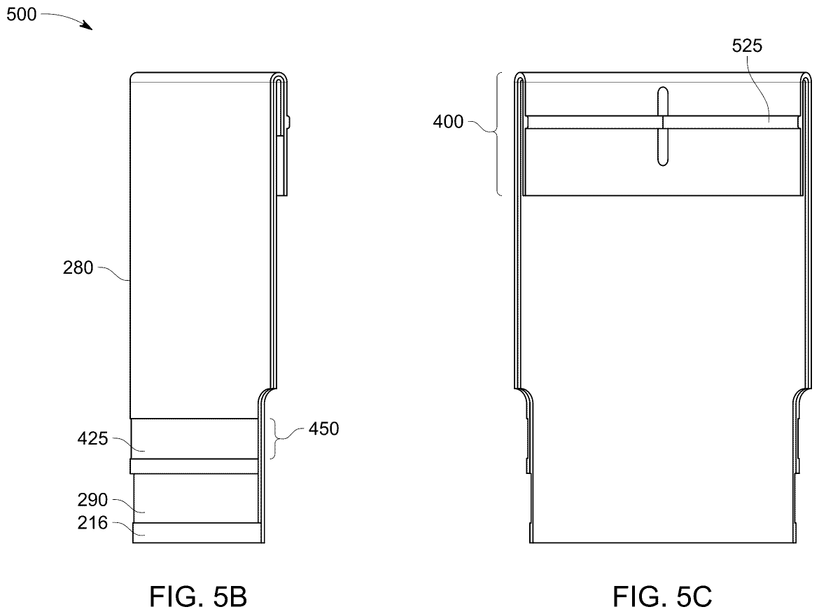

When installed, the hip and ridge shingle is secured by at least two nails located in a nail zone along the back portion 216 of the shingle adjacent to where the sealant 288 is generally applied. In conventional shingles, such nails often ended up in the sealant 288 (when located as shown in FIG. 3), due to inconsistent manufacturing processes and sealant migration or “walk”. Additionally, due to the presence of the sealant 288, conventional hip and ridge shingles have been unable to reinforce the nail zone to improve nail pull and wind performance. However, it has been discovered that a hip and ridge shingle with improved performance may be produced by applying sealant 525 to the bottom of the folded shingle, along the folded edge 400 (See, FIG. 5(c)). Accordingly, when installed, the sealant 525 that is located on the bottom of the folded edge 400 contacts and adheres to the nail zone of an underlying shingle when installed.

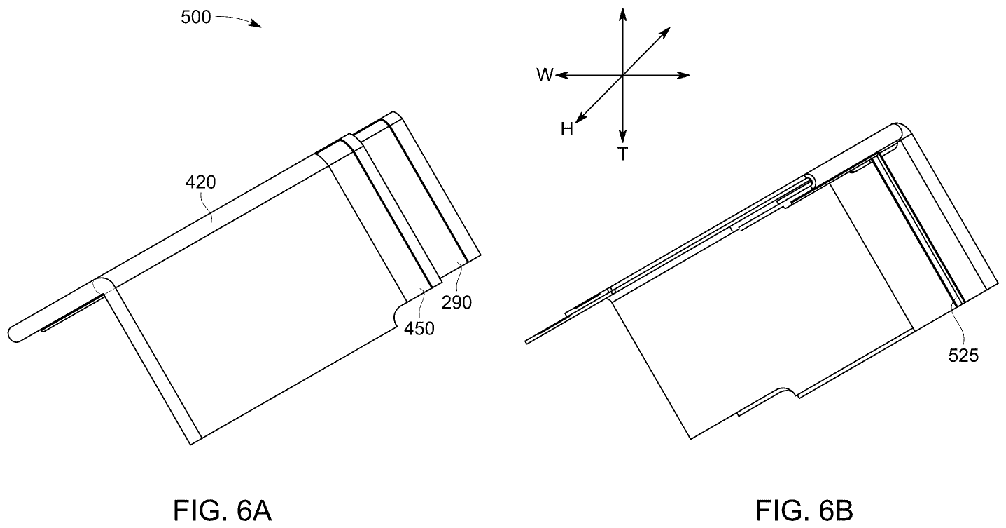

In accordance with the present inventive aspects, the nail zone of the improved hip and ridge shingle 500 comprises a reinforced nail zone 450, having a reinforcement material 425 applied thereto, in the location formerly occupied by a sealant 288 (See FIGS. 5(a) and 5(b), whereby FIG. 5(b) illustrates a side view of the shingle after being folded along centerline 280; See also, FIGS. 6(a) and 6(b) for alternative perspectives). The folded shingle has a height (H), a width (W), and a thickness (T).

The reinforced nail zone may be proximate or adjacent to the back edge 216. In any of the exemplary embodiments, the hip and ridge shingle 500 further includes a release section 290 applied in the exposed/uncovered portion of the underlay sheet 320. Reinforcing the nail zone reduces the occurrence of nail blow through during shingle installation and also improves shingle wind performance. Reducing the occurrence of nail blow through advantageously reduces the possibility of a roof leak if water travels under the shingle tab. A reinforced nail zone also improves the efficiency of the shingle installer by reducing the likelihood of nail blow through when the shingle is weakened due to high temperatures, such as when the roof or shingle temperature is above about 120 degrees F., or when nail gun air pressure is too high. The reinforced nail zone 450 may also provide a defined and relatively wide area in which the installer may nail. Advantageously, the reinforced nail zone 450 will increase the force required to pull a nail through the shingle, thereby reducing the likelihood of shingle blow off.

The nail zone reinforcement material 425 may comprise a continuous strip of reinforcement material, such as a woven or non-woven fabric. The reinforcement material 425 adheres to the asphalt-coated sheet overlay sheet 210. In any of the exemplary aspects, the reinforcement material 425 may be attached to the overlay sheet 210 by the asphalt coating composition. The reinforcement material 425, however, may be attached to the overlay sheet 210 by any suitable means, such as other adhesives. The reinforcement material 425 may be formed from any material for reinforcing and strengthening the nail zone of a shingle, such as, for example, paper, film, scrim material, and woven or non-woven glass fibers. In particular, the reinforcement material 425 may comprise a woven or nonwoven material, such as the reinforcement material described in U.S. Pat. No. 11,473,305, the contents of which are fully incorporated herein by reference.

The reinforcement material 425 may have any width W as desired for a particular application. In any of the exemplary aspects, the reinforcement material 425 has a width W between about 0.5 inches and about 3 inches, including, for example, between about 0.75 inches and 2.5 inches, between about 1 inch and 2.25 inches, between about 1.25 inches and 2 inches, and between about 0.75 inches and 1.5 inches. As illustrated in FIG. 5, the reinforcement material 425 may be disposed longitudinally along a portion of the bottom portion 216. If desired, the reinforcement material 425 may substantially cover the entire back portion 216 of the overlay sheet 210. It will be understood that the reinforcement material 425 need not extend width of the shingle 200 and may be disposed in one or more sections or portions on the shingle 200.

The reinforcement material 425 defines a reinforced nail zone 450 and may include text such as “NAIL HERE”. It will be understood, however, that any other text or other indicia may be included on the reinforcement material 425. It will also be understood that the reinforcement material 425 can be provided without such text or indicia. These indicia on the reinforcement material 425 ensure that the reinforced nail zone 450 may be easily and quickly identified by the shingle installer.

The reinforcement material 425 further defines an improved bonding surface for the relocated sealant 525. When a sealant is bonded to polymer modified asphalt, the debonding tendency is increased compared to a sealant bonded to a reinforcement material 425, particularly at low temperatures, such as temperatures below about 40 degrees F. This relatively strong debonding load between woven or non-woven fabric and sealants occurs because the woven or non-woven fabric mechanically bonds to the sealant. For example, mechanical attachment occurs as the sealant flows around individual filaments and fiber bundles within the woven or non-woven fabric during bonding. The energy required to debond the sealant from the woven or non-woven fabric is increased or comparable to the energy required to debond the polymer modified asphalt sealant from a shingle without a reinforced nail zone.

An additional advantage of using woven or non-woven fabric to reinforce the nail zone is that the fabric may be installed during shingle production. During shingle production, the woven or non-woven fabric may be pushed into the hot, filled-asphalt coating, such that some of the filled-asphalt bleeds up and around the individual fibers and fiber bundles of the fabric. This creates a positive mechanical bond between the fabric and the shingle substrate. Further, the filled-asphalt that bleeds up and into the fabric aids in forming a bond between the sealant and the shingle because the filled-asphalt diffuses into the sealant.

In some embodiments, the shingle may optionally further include one or more additional reinforcement materials positioned within any portion of the foldable region 226 of the overlay sheet. In some exemplary embodiments, at least one additional reinforcement material is included at or adjacent to the optionally perforated fold lines 232, 234 to further reinforce the folded edge 400. The additional reinforcement materials can mitigate against stresses resulting from folding of the shingle, which might otherwise lead to cracking over time (e.g., during temperature cycles).

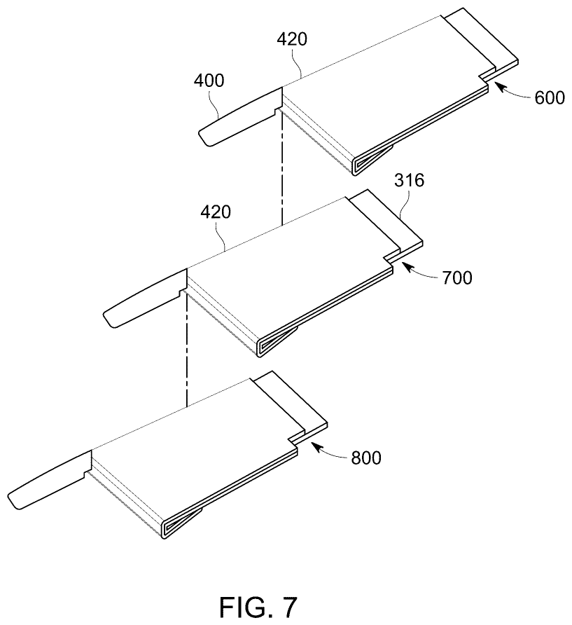

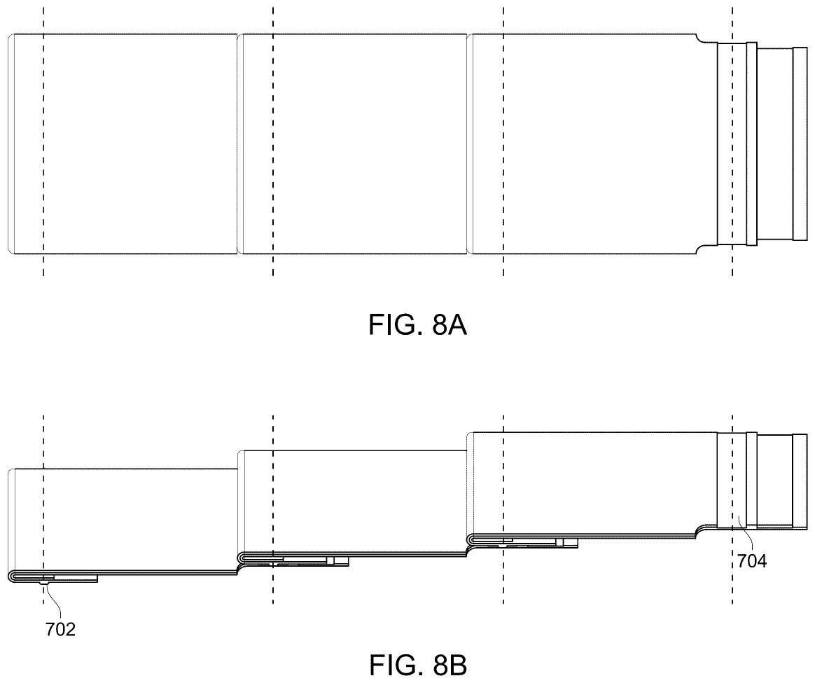

The hip and ridge shingles may be installed on the ridge of a roof in a nested fashion with the ridge bend 420 of one hip and ridge shingle 600 placed on top of the ridge bend 420 of a preceding hip and ridge shingle 700 below (with shingle 700 having been previously placed over shingle 800), as shown in FIG. 7 and FIGS. 8(a) and 8(b). The hip and ridge shingles 600, 700, 800 are stacked with the front edge 400 of one hip and ridge shingle 600 being stacked above the back edge 316 of the hip and ridge shingle 700 below. In this way, the single thickness back edge 316 of one hip and ridge shingle is protected by the more rigid folded front edge 400 of the adjacent shingle. The dashed lines in FIGS. 8(a) and 8(b) also illustrate the alignment of a sealant 702 (e.g., sealant 525) on a lower surface of each shingle and a nail zone 704 (e.g., nail zone 450) on an upper surface of each shingle.

To the extent not already described the different features and structures of the various embodiments of the present disclosure may be used in combination with each other as desired. For example, one or more of the features illustrated and/or described with respect to one aspect of the disclosure can be used with or combined with one or more features illustrated and/or described with respect to other aspects of the disclosure. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

1. A hip and ridge roofing material comprising:
an overlay sheet comprising a top overlay surface, a bottom overlay surface, a front portion, and a back portion, the overlay sheet comprising a first substrate coated with a first asphalt coating composition;
an underlay sheet comprising a top underlay surface and a bottom underlay surface, the underlay sheet comprising a second substrate coated with a second asphalt coating composition, wherein the overlay sheet is attached to the underlay sheet such that a portion of the top underlay surface extends beyond the back portion of the overlay sheet, forming an uncovered portion; and wherein the front portion of the overlay sheet is folded under the underlay sheet such that a front edge contacts the bottom underlay surface, forming a folded portion;
a release material located on the underlay sheet in the uncovered portion;
a reinforced nail zone located in the back portion of the top overlay sheet, proximate to the release material; and
a sealant located on a portion of the bottom surface of the folded portion.

2. The hip and ridge shingle according to claim 1, wherein the overlay sheet is attached to the underlay sheet by an adhesive.

3. The hip and ridge shingle according to claim 1, wherein the first asphalt coating composition comprises polymer modified asphalt coating.

4. The hip and ridge shingle according to claim 3, wherein the polymer modified asphalt coating comprises: asphalt; a polymer additive; and a secondary additive.

5. The hip and ridge shingle according to claim 4, wherein the secondary additive comprises one or more of a wax, a salt of a fatty acid ester, and an amide of a fatty acid.

6. The hip and ridge shingle according to claim 3, wherein the polymer modified asphalt coating comprises 85-99 wt. % asphalt, 1-13 wt. % polymer additive, and 1-6 wt. % wax.

7. The hip and ridge shingle according to claim 3, wherein the polymer modified asphalt coating further comprises a filler.

8. The hip and ridge shingle according to claim 1, wherein the reinforced nail zone comprises a strip of nail zone reinforcement material.

9. The hip and ridge shingle according to claim 8, wherein the strip of nail zone reinforcement material comprises a woven polyester fabric.

10. The hip and ridge shingle according to claim 1, wherein the sealant is positioned in a location on the foldable portion adapted to contact a reinforced nail zone of an adjacent hip and ridge shingle upon installation on a roof.

11. A hip and ridge roofing material comprising:
a laminated shingle having a foldable front portion, an opposing back portion, a top surface an opposing bottom surface, and a foldable centerline, wherein the laminated shingle includes:
an overlay sheet comprising a first substrate coated with a polymer modified asphalt coating composition attached to an underlay sheet comprising a second substrate coated with an at least partially oxidized asphalt coating composition, wherein an upper surface of the overlay sheet defines the top surface and a lower surface of the underlay sheet defines the bottom surface, and wherein the foldable front portion of the laminated shingle is folded down below the underlay sheet such that a front edge of the foldable front portion contacts the bottom surface, forming a folded portion;
a reinforced nail zone located on the top surface in the back portion, proximate to a back edge; and
a sealant located on a bottom surface of the folded portion, wherein the laminated shingle is foldable along the centerline for application to a roof.

12. The hip and ridge roofing material according to claim 11, wherein the overlay layer is attached to the underlay layer by an adhesive.

13. The hip and ridge roofing material according to claim 11, wherein the polymer modified asphalt coating comprises: asphalt; a polymer additive; and a secondary additive.

14. The hip and ridge roofing material according to claim 13, wherein the secondary additive comprises one or more of a wax, a salt of a fatty acid ester, and an amide of a fatty acid.

15. The hip and ridge roofing material according to claim 11, wherein the polymer modified asphalt coating comprises 85-99 wt. % asphalt, 1-13 wt. % polymer additive, and 1-6 wt. % wax.

16. The hip and ridge roofing material according to claim 11, wherein the polymer modified asphalt coating further comprises a filler.

17. The hip and ridge roofing material according to claim 11, wherein the reinforced nail zone comprises a strip of nail zone reinforcement material.

18. The hip and ridge roofing material according to claim 17, wherein the strip of nail zone reinforcement material comprises a woven polyester fabric.

19. The hip and ridge roofing material according to claim 11, wherein the sealant is positioned in a location on the foldable portion adapted to contact a reinforced nail zone of an adjacent hip and ridge shingle upon installation on a roof.

20. A method for producing a hip and ridge shingle comprising:
laminating an overlay sheet comprising a top overlay surface, a bottom overlay surface, a front portion, and a back portion to an underlay sheet comprising a top underlay surface and a bottom underlay surface, forming a laminated shingle, wherein at least a portion of the overlay sheet is attached to the underlay sheet with an adhesive, such that a portion of a top surface of the underlay sheet extends beyond a back portion of the overlay sheet, forming an uncovered portion;
folding a front portion of the overlay sheet under the underlay sheet such that a front edge of the overlay sheet contacts a bottom surface of the underlay sheet, forming a folded portion;
applying a release material to the underlay sheet in the uncovered portion;
applying a nail reinforcement material to the back portion of the overlay sheet, proximate to the release material;
applying a sealant to a portion of the bottom surface of the folded portion; and
folding the laminated shingle along a centerline for application to a hip or ridge of a roof.
